(19) United States
(12) Patent Application Publication
(10) Pub. No.: US 2005/0238807 A1
(43) Pub. Date: Oct. 27, 2005

(54) Refurbishment of a coated chamber component

(75) Inventors: Yixing Lin, Saratoga, CA (US); Dajiang Xu, Milpitas, CA (US); Robert Haney, Mountain View, CA (US); Clifford Stow, Santa Clara, CA (US)

Correspondence Address: APPLIED MATERIALS, INC.;Patent Department, M/S 2061, P.O. Box 450A, Santa Clara, CA, 95052, US

(73) Assignee: Applied Materials, Inc.

(21) Appl. No.: 10/833,975

(22) Filed: Apr. 27, 2004

(51) Int. Cl. B05D 3/02

(52) U.S. Cl. 427/248.1; 427/140; 427/372.2

(57) ABSTRACT

A component of a process chamber is cleaned and refurbished. The component has a structure with an overlying coating having of a first layer. To refurbish the component, the first layer is removed to form an exposed surface on the structure. During or after the removal of the coating, the exposed surface is cleaned with a cleaning fluid, which deposits cleaning residue on the exposed surface. The exposed surface is heated in a substantially non-oxidizing atmosphere to a temperature that is sufficiently high to vaporize the cleaning residue from the surface, thereby forming a cleaned surface. A second layer is formed over the cleaned surface.

### BACKGROUND

The present invention relates to the cleaning and coating of process chamber components.

In the processing of substrates, such as semiconductor wafers and displays, a substrate is placed in a process chamber and exposed to an energized gas to deposit, or etch material on the substrate. During such processing, process residues are generated and can deposit on internal surfaces in the chamber. For example, in sputter deposition processes, material sputtered from a target for deposition on a substrate also deposits on other component surfaces in the chamber, such as on deposition rings, shadow rings, wall liners, and focus rings. In subsequent process cycles, the deposited process residues can “flake off” of the chamber surfaces to fall upon and contaminate the substrate.

To reduce the contamination of the substrates by process residues, the surfaces of components in the chamber can be textured. Process residues adhere better to the textured surface and are inhibited from falling off and contaminating the substrates in the chamber. The textured component surface can be formed by coating a roughened surface of a component, as described for example in U.S. patent application Ser. No. 09/895,862 to Shyh-Nung Lin et al, filed on Jun. 27, 2001, commonly assigned to Applied Materials, and U.S. patent application Ser. No. 10/113,847 to Shyh-Nung Lin et al, filed on Mar. 27, 2002, commonly assigned to Applied Materials, both of which are herein incorporated by reference in their entireties.

However, after a number of process cycles, the coated components require cleaning and refurbishing to remove accumulated process residues. For example, when chamber components are used in a pre-clean process to sputter material from the surface of metal interconnects, the sputtered material accumulates on the surfaces of the component with each process cycle. The accumulated process deposits cause thermal expansion stresses that result in delamination, cracking, and flaking-off of the coating from the underlying structure. The plasma in the chamber can penetrate through damaged areas of the coating to erode the exposed surfaces of the underlying structure, eventually leading to failure of the component. Thus, a refurbishing process is typically performed to clean and refurbish the coated component after a number of substrates have been processed. The refurbishment process reduces the incidence of spalling or peeling of the coating from the component during the processing of substrates, and thus reduces the contamination of substrates processed in the chamber.

In one example of a refurbishment process, the coating is removed from the underlying component structure, for example, by chemically etching away the coating from the component. A bead blasting process can then be performed to remove any remaining particles of coating, as well as roughen the surface of the component to improve adherence of a subsequently described coating, as described for example in U.S. application Ser. No. 10/691,418 to Yixing Lin et al, filed on Oct. 22, 2003, and commonly assigned to Applied Materials, which is herein incorporated by reference. After the bead blasting process, a fresh textured coating is applied, for example by a twin-wire arc coating method. The fresh coating can be rinsed with a cleaning fluid, such as de-ionized water, and the washed coating is baked for a sufficient duration to remove volatile material from the coating.

However, it has been found that when such a fabricated component is used in a process chamber, the chamber often requires an excessively long time to pump down to a desirable pressure, due to volatile materials remaining on the refurbished component. For example, it can take up to 20 hours to achieve a desired chamber pressure with a refurbished component, which can unacceptably delay the processing of substrates. In one version, a pre-baking step can be performed to bake the underlying structure in an oven to remove volatile materials before applying the coating, as described in aforementioned U.S. patent application Ser. Nos. 10/113,847 and 09/895,862 to Lin et al. However, this pre-baking step has been discovered to yield unsatisfactory adhesion of the subsequently applied coating to the underlying structure. The less strongly adhered coating can spall from the underlying structure, resulting in corrosion of the underlying structure and contaminating substrates being processed in the chamber. Also, the pump down time required to achieve appropriate chamber pressures remains undesirably long with such pre-baked components.

Thus, it is desirable to have a method of refurbishing and cleaning a component that does not result in unacceptably long pumping-down times in the chamber in which the component is being used. It is furthermore desirable to have a method of refurbishing a component that provides improved component corrosion resistance, and thus reduces the contamination of processed substrates.

### SUMMARY

In one version, a component of a process chamber is refurbished. The component has a structure with an overlying coating that is a first layer. To refurbish the component, the first layer is removed from the component to form an exposed surface on the structure. During or after removal of the first layer, the exposed surface is cleaned with a cleaning fluid, which deposits cleaning residue on the exposed surface. The exposed surface is heated in a substantially non-oxidizing atmosphere to a temperature that is sufficiently high to vaporize the cleaning residue from the surface, thereby forming a cleaned surface. A second layer is formed over the cleaned surface.

In another version of a refurbishment process, the coated component has a first metal layer that is removed to form an exposed component surface. The exposed surface is cleaned with a first cleaning fluid during or after removal of the first metal layer, which deposits first cleaning residue on the exposed surface. The exposed surface is textured by propelling blasting beads towards the surface. In a first baking step, the exposed surface is heated in a substantially non-oxidizing environment to a temperature that is sufficiently high to vaporize first cleaning residue from the surface. The substantially non-oxidizing atmosphere has less than about 1% by volume of oxygen gas. A second metal layer is formed over the exposed surface, the second metal layer having a top surface. The top surface of the second metal layer is cleaned with a second cleaning fluid, which deposits second cleaning residue on the top surface. In a second baking step, the top surface of the second metal layer is heated to a temperature that is sufficiently high to vaporize second cleaning residue from the top surface.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1a is schematic side view of an embodiment of a component having an overlying coating;

FIG. 1b is a schematic side view of the component of FIG. 1a after removal of the coating, and having volatile residues on the exposed surface of the component;

FIG. 1c is a schematic side view of the component of FIG. 1b after a pre-baking step has been performed;

FIG. 2 is a flow chart illustrating an embodiment of a component refurbishment process; and

FIG. 3 is a sectional side view of an embodiment of a process chamber having one or more coated components.

### DESCRIPTION

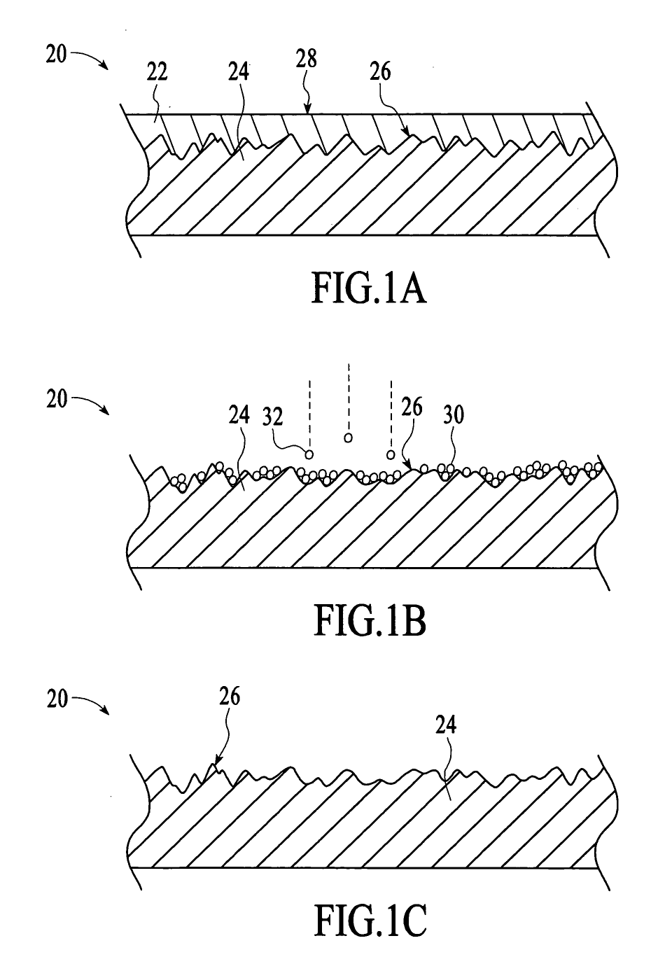

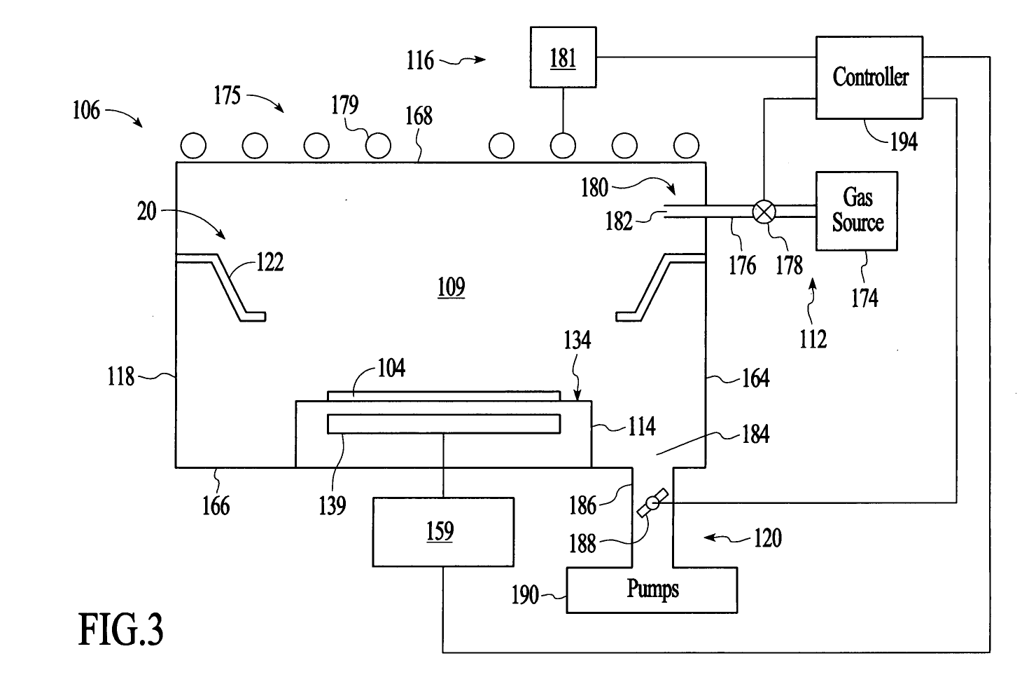

The present process is suitable for cleaning and refurbishing a component 20 having a coating 22, as shown for example in FIG. 1. The process provides improved cleaning and refurbishing of the component 20, and improves the removal of volatile residues from the component 20. Removing volatile residues can reduce the overall pumping time required to achieve a desired pressure level in a chamber 106. The process may be used to clean and refurbish one or more of components 20 in the chamber 106 that are susceptible to erosion, such as for example, portions of one or more of a gas delivery system 112 that provides process gas in the chamber 106, a substrate support 114 that supports the substrate 104 in the chamber 106, a gas energizer 116 that energizes the process gas, chamber enclosure walls 118 and shields 122, and a gas exhaust 120 that exhausts gas from the chamber 106, exemplary embodiments of all of which are shown in FIG. 3. For example, in a pre-clean chamber 106 as shown in FIG. 3, the coated components 20 can comprise any of a chamber enclosure wall 118, such as a chamber cover or ceiling 168, a chamber shield 120, a gas distributor 180, an exhaust conduit 186, and a portion of the substrate support 114.

The chamber component 20 comprises an underlying structure 24 having an overlying coating 22 that covers at least a portion of the structure 24, as shown in FIG. 1a. The underlying structure 24 comprises a material that is resistant to erosion from an energized gas, such as an energized gas formed in a substrate processing environment. For example, the structure 24 can comprise a metal, such as at least one of aluminum, titanium, tantalum, stainless steel, copper and chromium. The structure 24 can also comprise a ceramic material, such as for example at least one of alumina, silica, zirconia, silicon nitride and aluminum nitride. A surface 26 of the structure 24 contacts the coating 22, and desirably has a surface roughness that improves adhesion of the overlying coating 22 to the structure 24. For example, the surface 26 can have a surface roughness of at least about 2.0 micrometers (80 microinches.) The coating 22 typically comprises a layer of metal material that has resistance to erosion in an energized gas, such as for example, at least one of aluminum, titanium, tantalum, copper and chromium. The coating 22 can also have a top surface 28 that is textured, such that process residues generated in the processing of substrates 104 can better adhere to the surface 28 of the coating 22.

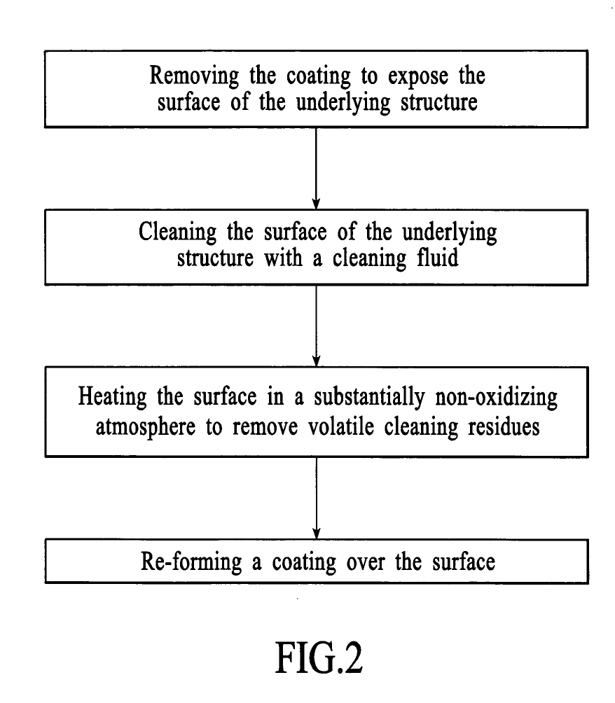

The coated component 20 can be cleaned and refurbished after processing one or more substrates 104 to remove accumulated process residues and eroded portions of the coating from the component 20. In one version, the component 20 can be refurbished by removing the coating 22 and process residues, and by performing various cleaning processes to clean the underlying structure surface 26. Cleaning the underlying surface 26 provides enhanced bonding between the underlying structure 24 and a subsequently re-formed coating 22. An example of an improved method of cleaning and refurbishing a process chamber component 20 is shown in the flow chart of FIG. 2. This method generally comprises removing the coating 22, cleaning the surface 26 with a cleaning fluid during or after removal of the coating 22, heating the surface 26 in a substantially non-oxidizing atmosphere to remove volatile cleaning residues 30 from the surface 26, and re-forming a coating 22 over the surface 26.

The coating 22 is removed from the structure 24 by a suitable method to form an exposed underlying surface 26. In one version, the coating 22 is removed from the structure 24 by immersing the surface 28 of the coating 22 in a cleaning fluid, such as an acidic or basic cleaning solution. The cleaning fluid desirably comprises a chemical component capable of removing the coating 22, for example, by dissolving the coating material. The cleaning fluid can also be capable of removing process deposits that have accumulated on the coating surface 28. In one version, the surface 28 of the coating 22 is immersed in an acidic cleaning solution comprising at least one of HF, HNO₃, HCl, H₃PO₄ and H₂SO₄. In another version, the surface 28 is immersed in a basic cleaning solution comprising at least one of KOH, NH₄OH, NaOH, and K₂CO₃. In one version, the surface 28 is immersed in more than one cleaning solution to provide the desired removal of both the coating 22 and process residues, as described for example in U.S. patent application Ser. No. 10/304,535 filed on Nov. 25^{th}, 2002, to Wang et al., which is incorporated herein by reference in its entirety. For example, the surface 28 of the coating 22 can be immersed in an acidic cleaning solution comprising from about 2 M to about 8 M HF, such as about 5 M HF and from about 2 M HNO₃ to about 15 M HNO₃, such as about 12 M HNO₃, to remove process residues. The surface 28 is then immersed in a basic cleaning solution comprising from about 1 M to about 8 M, such as about 3 M KOH, to remove the coating 22. FIG. 1b shows the component 20 after the coating 22 has been removed and a surface 26 of the underlying structure 24 has been exposed.

Once the coating 22 has been removed, one or more subsequent cleaning steps can be performed to remove any remaining process deposits and particles of coating material from the exposed surface 26 of the structure 24. In one version, the surface 26 is cleaned by immersing or rinsing the surface with a cleaning fluid comprising de-ionized water, to remove acidic or basic residues remaining from previous cleaning steps. The surface 26 can also be ultrasonically agitated while it is immersed in a cleaning fluid, such as de-ionized water, for example by introducing sound waves to the surface 26 to lightly shake the surface 26. Cleaning fluids other than de-ionized water may also by applied to the surface 26 to clean residues from the surface.

In one version, the exposed surface 26 is bead blasted after at least a portion of the coating 22 has been removed. Bead blasting the surface 26 can improve the adhesion of a subsequently applied coating by remove any loose particles from the surface 26, such as any remaining coating particles. Bead blasting can also remove intermetallic materials that can develop at the interface between the coating 22 and structure 24 while processing a substrate with the component, and which can weaken the bond between the coating 22 and structure 24. Bead blasting can also re-texture the surface 26 to restore the desired surface roughness to the surface 26, which can be reduced, for example, by chemical cleaning solutions used to remove the coating 22 and clean the surface 26.

In a bead blasting process, solid blasting beads 32 are propelled toward the surface 26 of the underlying structure 24 by pressurized gas, as shown for example in FIG. 1b. The blasting beads 32 typically comprise a hard material, such as alumina, that impacts and excavates a portion of the component surface 26 to impart a texture to the surface 26. In one version of a bead blasting process suitable for texturing a surface, blasting beads 32 having a diameter of from about 400 micrometers to about 1000 micrometers are propelled towards the surface 26 to roughen the surface 26. This bead size can correspond to a grit mesh size of, for example, from about 24 to about 70. A suitable pressure of gas used to propel the beads can be a pressure of at least about 138 kPa (20 psi), such as from about 138 kPa (20 psi) to about 827 kPa (120 psi). Other suitable bead blasting conditions include: an angle of incidence of the beads relative to the surface 26 of from about 45 to about 90 degrees, and even from about 50 to about 70 degrees; and a standoff distance traveled by the beads from a bead blaster to the surface 26 of the underlying structure 24 of from about 10 cm to about 25 cm, such as from about 10 cm to about 15 cm.

The bead blasting process may also comprise more than one bead blasting step, as described for example in U.S. patent application Ser. No. 10/691,418, filled Oct. 22, 2003, to Lin et al, which is herein incorporated by reference in its entirety. For example, the bead blasting process may comprise a first penetrative bead blasting step with smaller bead sizes and lower bead propelling pressures that can penetrate cracks and crevices in the surface 26 to remove impurities such as intermetallic compounds form the surface 26. The penetrative bead blasting step can be followed by a texturizing bead blasting step comprising larger bead sizes and higher gas pressures, such as for example the bead sizes and gas pressures described above, that re-texturizes the surface 26.

One or more cleaning steps can be performed after the bead blasting process to remove any blasting beads 32 or remaining particles from the surface 26, such as portions of the component surface that become loose during the bead blasting process. For example, the surface 26 can be cleaned by immersing or rinsing with de-ionized water, or with another cleaning fluid, and can also be ultrasonically agitated. A pressurized flow of N₂ can also be provided to clean the surface 26 of the underlying structure 24.

It has been discovered that cleaning and refurbishment of the component is improved by performing a pre-baking step to remove volatile residues 30 from the surface 26 before a coating 22 is re-applied. The volatile residues 30 can deposit on the surface 26 as a result of exposing the surface 26 to cleaning fluids during the refurbishment process, as shown in FIG. 1b. For example, the volatile residues 30 may comprise residues that remain on the surface 26 from a coating removal step, such as residues from acidic and basic solutions. As another example, the volatile residues 30 can comprise residues that remain on the surface 26 after a post-bead blasting cleaning step, such as residues from a de-ionized water cleaning step. The removal of these residues 30 is desirable because it can reduce the amount of time required to achieve a desired pressure in a chamber having the refurbished component 20. Removal of the residues 30 can also provide improved adhesion of a subsequently applied coating 22, and can reduce the corrosion of the surface 26 from any remaining residues.

In the pre-baking step, the surface 26 is heated to a temperature that is sufficiently high to vaporize, or “bake off,” the remaining volatile residues 30. The temperature is desirably high enough to remove the residues 30 substantially without damaging the underlying surface 26, for example, without melting or warping the surface 26. A suitable temperature may be, for example, a temperature of at least about 100° C., and even at least about 120° C., such as from about 120° C. to about 140° C. For example, for a component surface 26 comprising stainless steel, a suitable temperature to remove the volatile residues may be from about 115° C. to about 125° C. Optionally, a temperature as low as about 80° C. may be suitable to remove residues when heating the surface 26 under a vacuum pressure. The surface 26 can be heated to the temperature for a duration suitable to remove the residues, such as for example, a duration of at least about 1 hour and less than about 3 hours, such as from about 1 hour to about 2 hours. The surface 26 can be heated by, for example, placing the structure 24 in a furnace, radiatively heating the component 20 with heating lamps, or another suitable heating method. An embodiment of a component 20 having a surface 26 that is substantially free of volatile residues 30 is shown is FIG. 1c.

It has been further discovered that improved heating results are provided by heating the surface 26 in a substantially non-oxidizing atmosphere. The substantially non-oxidizing atmosphere inhibits the formation of oxides on the surface 26 of the component 20. Reducing the formation of these oxides is important, because they can otherwise adversely affect the adhesion of a subsequently applied coating 22, and can cause delamination of the coating 22 from the surface 26. Also, by reducing the adhesion of the coating 22 to the surface 26 and forming a weaker bond therebetween, the formation of the oxides allows for higher amounts of volatile residues to be retained in any gaps that remain between the more loosely bonded surface 26 and coating 22. These volatile residues can undesirably increase the amount of time required to pump down a process chamber having the component to a suitable pressure. Inhibiting the formation oxides can be particularly important for surfaces 26 formed from metal, as these surfaces can be especially susceptible to oxidation. A suitable substantially non-oxidizing environment is preferably substantially absent oxidizing agents, such as for example, oxygen gas or ozone. For example, a suitable substantially non-oxidizing environment may comprise less than about 1% by volume of oxygen gas, such as from about 0.1% to about 0.9% by volume of oxygen gas, and even less than about 0.5% by volume of oxygen gas, such as less than about 0.01% by volume of oxygen gas.

In one version, the surface 26 is heated in a substantially non-oxidizing atmosphere comprising nitrogen. The nitrogen-containing atmosphere comprises a sufficient concentration of nitrogen gas (N₂) to inhibit oxidation of the surface. A suitable concentration of nitrogen may be a concentration of at least about 99% by volume of nitrogen gas, such as from about 99.0% to about 99.9% by volume of nitrogen gas, and even at least about 99.5% by volume, such as at least about 99.99% by volume of nitrogen gas. The surface 26 can be heated in the nitrogen-containing atmosphere by placing the structure 24 in a heating chamber (not shown), such as for example a furnace or heating oven, and maintaining a desired composition of nitrogen gas in the heating chamber. In one version, nitrogen gas is continuously flowed into the heating chamber and over the surface 26 of the component 20 to purge oxidizing agents such as oxygen gas from the heating chamber. A pressure of gas in the heating chamber may typically be maintained in a range that is about atmospheric pressure (101 kPascals.)

In another version, the surface 26 is heated in a substantially non-oxidizing atmosphere by maintaining the surface 26 in a low pressure environment. For example, the surface 26 may be heated in a heating chamber that is capable of maintaining a vacuum pressure. Maintaining a low pressure of gases about the surface 26 provides fewer oxidative species that could react with and oxidize the surface 26. In one version, the surface 26 is heated while maintaining a pressure of the environment about the surface 26 that is less than atmospheric pressure (˜101 kilopascals), such as from at least about 13.3 pascals (˜100 mTorr) to about 13.3 kilopascals (˜100 Torr), and even at a pressure of less than about 13.3 kilopascals (˜100 Torr). Furthermore, a temperature that is suitable to vaporize residues from the surface 26 in a low-pressure environment may be lower than the temperature required in an environment that is at about atmospheric pressure. This may be advantageous especially for surfaces 26 that are easily deformed or warped by high heat. An example of a temperature suitable to vaporize residues from the surface 26 at a vacuum pressure may be a temperature of at least about 80° C., such as from about 80° C. to about 120° C., and even from about 100° C. to about 120° C.

After heating the surface 26 to remove the volatile residues, a coating 22 is re-formed over at least a portion of the surface 26. The coating 22 is desirably applied shortly after the surface 26 has been heated to reduce the condensation of volatile material onto the surface 26. The surface may also be allowed to cool for a short duration to a temperature that is appropriate for the coating process. For example, the coating 22 may be applied to the surface 26 in less than about 5 minutes after the heating step has ended, and once the surface 26 has cooled to a temperature below about 60° C.

The coating 22 can comprise a layer the same or different material as the original coating removed by the refurbishment process, for example the coating 22 can comprise one or more metals that have substantial resistance to erosion in the substrate processing chamber, such as at least one of aluminum, titanium, copper and chromium. The coating 22 is applied by a method that provides a strong bond between the coating 22 and the underlying structure 24 to protect the underlying structure 24. For example, the coating 22 may be applied by one or more of a chemical or physical deposition process, or by a flame spraying or thermal spraying method, such as a twin wire arc spray method, plasma arc spray method, or oxy-fuel gas flame. An example of a refurbished component 20 having the coating 22 is shown in FIG. 1a.

In one version, the coating 22 comprises a metal layer that is applied to the cleaned surface 306 by a twin wire arc spray process, as for example described in U.S. Pat. No. 6,227,435 B1, issued on May 8^{th}, 2001 to Lazarz et al, and U.S. Pat. No. 5,695,825 issued on Dec. 9^{th}, 1997 to Scruggs, both of which are incorporated herein by reference in their entireties. In the twin wire arc thermal spraying process, a thermal sprayer (not shown) comprises two consumable electrodes that are shaped and angled to allow an electric arc to form therebetween. For example, the consumable electrodes may comprise twin wires formed from the metal to be coated on the surface, which are angled towards each other to allow an electric discharge to form near the closest point. An electric arc discharge is generated between the consumable electrodes when a voltage is applied to the consumable electrodes as a carrier gas, such as one or more of air, nitrogen or argon, is flowed between the electrodes. Arcing between the electrodes atomizes and at least partially liquefies the metal on the electrodes, and carrier gas energized by the arcing electrodes propels the molten particles out of the thermal sprayer and towards the surface 26 of the underlying structure 24. The molten particles impinge on the surface 26 of the underlying structure 24, where they cool and condense to form a conformal coating 22. When wires are used as the consumable electrodes, the wires may be continuously fed into the thermal sprayer to provide a continuous supply of the metal material.

Operating parameters during thermal spraying are selected to be suitable to adjust the characteristics of the coating material application, such as the temperature and velocity of the coating material as it traverses the path from the thermal sprayer to the underlying structure surface 26. For example, gas flows, power levels, powder feed rate, carrier gas flow, standoff distance from the thermal sprayer to the surface 26, and the angle of deposition of the coating material relative to the surface 26 can be selected to improve the application of the coating material and the subsequent adherence of the coating 22 to the underlying structure surface 26. For example, the voltage between the consumable electrodes may be selected to be from about 10 Volts to about 50 Volts, such as about 30 Volts. Additionally, the current that flows between the consumable electrodes may be selected to be from about 100 Amps to about 1000 Amps, such as about 200 Amps. The power level of the thermal sprayer is usually in the range of from about 6 to about 80 kilowatts, such as about 10 kiloWatts.

The standoff distance and angle of deposition can also be selected to adjust the deposition characteristics of the coating material on the surface 26. For example, the standoff distance and angle of deposition can be adjusted to modify the pattern in which the molten coating material splatters upon impacting the surface, to form for example, “pancake” and “lamella” patterns. The standoff distance and angle of deposition can also be adjusted to modify the phase, velocity, or droplet size of the coating material when it impacts the surface 26. In one embodiment, the standoff distance between the thermal sprayer and the surface is about 15 cm, and the angle of deposition of the coating material onto the surface 26 is about 90 degrees.

The velocity of the coating material can be adjusted to suitably deposit the coating material on the surface 26. In one embodiment, the velocity of the powdered coating material is from about 100 to about 300 meters/second. Also, the thermal sprayer may be adapted so that the temperature of the coating material is at least about melting temperature when the coating material impacts the surface. Temperatures above the melting point can yield a coating of high density and bonding strength. For example, the temperature of the energized carrier gas about the electric discharge may exceed 5000° C. However, the temperature of the energized carrier gas about the electric discharge can also be set to be sufficiently low that the coating material remains molten for a period of time upon impact with the surface 26. For example, an appropriate period of time may be at least about a few seconds.

The thermal spraying process parameters are desirably selected to provide a coating 22 having desired structure and surface characteristics, such as for example a desired coating thickness, coating surface roughness, and the porosity of the coating, which contribute to the improved performance of the coated components. The thickness of the coating 22 can affect how well the coating 22 adheres to the underlying structure 24 and the erosion resistance of the component 20. A suitable thickness of the coating 22 may be, for example, from about 152 micrometers (0.006 inches) to about 508 micrometers (0.02 inches). For an underlying structure 24 covered by an aluminum coating 22, such as a coated stainless steel or titanium structure, a suitable thickness of the coating 22 may be from about 254 micrometers (0.01 inches) to about 508 micrometers (0.02 inches), such as about 304 micrometers (0.012 inches.) The thermal spraying process parameters can also be selected to provide a coating 22 having a textured surface 28 to which process residues can adhere. For example, the coating 22 may have a textured surface 28 having a surface roughness of from about 25 micrometers (1000 microinches) to about 50.8 micrometers (2000 microinches.)

Once the coating 22 has been applied, the surface 28 of the coating 22 may be cleaned of any loose coating particles or other contaminants. The surface can be cleaned with a cleaning fluid, such as at least one of the cleaning fluids described above, including water, an acidic cleaning solution and a basic cleaning solution, and optionally by ultrasonically agitating the component 20. In one version, the surface 28 is cleaned by rinsing with de-ionized water.

The coating surface 28 can then be baked in a post-baking step to remove any volatile materials left by the cleaning and/or coating process. A suitable post-baking step comprises heating the surface 28 to a temperature of at least about 100° C., such as from about 100° C. to about 130° C., and even at least about 140° C., for a duration of at least about 30 minutes, such as from about 30 minutes to about 2 hours hours, and even about 3 hours. For example, for a coating 22 comprising aluminum, the surface 28 may be heated to a temperature of from about 100° C. to about 120° C. for at least about 1 hour. While a substantially non-oxidizing atmosphere may be provided, it may not always be necessary to perform the post-baking step in a non-oxidizing environment. In one version, it may even be desirable to form oxides on the coating surface 28 to provide resistance to erosion by energized gases.

Performing the pre-baking step that heats the surface 26 of the component 20 in the substantially non-oxidizing atmosphere to remove volatile residues 30, before applying a coating 22 over the surface 26, can enhance performance of the component 20 and improve process efficiency. In one version, a chamber 106 having a component 20 that has been newly refurbished with the substantially non-oxidizing pre-baking step requires only about 2 hours to pump down to a desired pressure of about 6.7×10-5 Pa (˜5×10⁻⁷ Torr.) In comparison, the same chamber 106 having a component prepared without the substantially non-oxidizing pre-baking step can require at least about 18 hours to pump down to the same pressure. Accordingly, the component 20 refurbished with the substantially non-oxidizing pre-baking step can increase the rate at which a desired pressure is obtained by at least about 9 times that of components prepared without the pre-baking step, and thus improves the efficiency with which the chamber 106 having the component 20 can be operated.

An example of a suitable process chamber 106 having a component refurbished according to the process is shown in FIG. 3. The chamber 106 can be a part of a multi-chamber platform (not shown) having a cluster of interconnected chambers connected by a robot arm mechanism that transfers substrates 104 between the chambers 106. In one embodiment, the chamber 106 comprises a pre-clean chamber 106 that is capable of cleaning a substrate 104, for example to remove native oxide from the surfaces of metal interconnects such as copper, aluminum and metal silicide, before a subsequent deposition stage. An example of a pre-clean chamber 106 in which components cleaned according to the method may be provided is a PCII chamber, available from Applied Materials Inc, Santa Clara. The chamber 106 comprises enclosure walls 118 that enclose a process zone 109, and that include sidewalls 164, a bottom wall 166, and a ceiling 168. Other chamber walls can include one or more shields 122 that shield the enclosure walls 118 from energized gas in the process zone.

A process gas, such as a cleaning gas, is introduced into the chamber 106 through a gas delivery system 112 that includes a process gas supply comprising one or more gas sources 174 that feed at least one conduit 176 having a gas flow control valve 178, such as a mass flow controller, to pass a set flow rate of the gas therethrough. The gas conduit feeds a gas distributor 180 having one or more gas outlets 182 in the chamber 106. The gas distributor 180 may also comprise a showerhead gas distributor (not shown). The process gas may comprise a non-reactive gas, such as argon or xenon, which is capable of being energized to impinge upon and sputter material such as native oxide from the substrate 104. The process gas may also comprise a reactive gas, such as a hydrogen-containing gas, that is capable of reacting with material such as a native oxide on the substrate 104. Spent process gas and byproducts are exhausted from the chamber 106 through an exhaust 120 which includes one or more exhaust ports 184 that receive spent process gas and pass the spent gas to an exhaust conduit 186 in which there is a throttle valve 188 to control the pressure of the gas in the chamber 106. The exhaust conduit 186 feeds one or more exhaust pumps 190. Typically, the pressure of the gas in the chamber 106 is set to sub-atmospheric levels.

The process gas may be energized to process the substrate 104 by a gas energizer 116 that couples energy to the process gas in the process zone 109 of the chamber 106. In one version, the gas energizer 116 comprises an antenna 175 comprising one or more inductor coils 179 to inductively couple energy to the process gas. The gas energizer 116 further comprises an antenna power supply 181, such as an RF power supply, that provides a power level to the antenna 175. The gas energizer 116 can further comprise comprises process electrodes that may be powered by an electrode power supply 159 to energize the process gas. The process electrodes may include an electrode that is or is in a wall, such as a sidewall 164 or ceiling 168 of the chamber 106 that may be capacitively coupled to another electrode, such as an electrode 139 in the support 114 below the substrate 104.

The chamber 106 comprises a substrate support 114 to support the substrate 104. The substrate support 114 may be electrically floating or may comprise an electrode 139 that is biased by an electrode power supply 159, such as an RF power supply. The substrate support 114 can also comprise a shutter disk that can protect the upper surface 134 of the support 114 when the substrate 104 is not present, and may further comprise one or more rings, such as cover rings, that protect the surface 134 of the support 114. In operation, the substrate 104 is introduced into the chamber 106 through a substrate loading inlet (not shown) in a sidewall 164 of the chamber 106 and placed on the support 114. The support 114 can be lifted or lowered by support lift bellows and a lift finger assembly (not shown) can be used to lift and lower the substrate onto the support 114 during transport of the substrate 104 into and out of the chamber 106.

The chamber 106 can be controlled by a controller 194 that comprises program code having instruction sets to operate components of the chamber 106 to process substrates 104 in the chamber 106, as shown for example in FIG. 3. For example, the controller 194 can comprise a substrate positioning instruction set to operate one or more of the substrate support 114 and substrate transport to position a substrate 104 in the chamber 106; a gas flow control instruction set to operate the gas delivery system 112 and flow control valves 178 to set a flow of gas to the chamber 106; a gas pressure control instruction set to operate the exhaust 120 and throttle valve 188 to maintain a pressure in the chamber 106; a gas energizer control instruction set to operate the gas energizer 116 to set a gas energizing power level; a temperature control instruction set to control temperatures in the chamber 106; and a process monitoring instruction set to monitor the process in the chamber 106.

Although exemplary embodiments of the present invention are shown and described, those of ordinary skill in the art may devise other embodiments which incorporate the present invention, and which are also within the scope of the present invention. For example, other chamber components than the exemplary components described herein can also be cleaned. Additional cleaning steps other than those described could also be performed, and the cleaning steps could be performed in an order other than that described. Furthermore, relative or positional terms shown with respect to the exemplary embodiments are interchangeable. Therefore, the appended claims should not be limited to the descriptions of the preferred versions, materials, or spatial arrangements described herein to illustrate the invention.

1. A method of refurbishing a component of a process chamber, the component comprising a structure having an overlying coating comprising a first layer, the method comprising:
(a) removing the first layer to form an exposed surface on the structure;
(b) during or after (a), cleaning the exposed surface with a cleaning fluid, thereby depositing cleaning residue on the exposed surface;
(c) heating the surface in a substantially non-oxidizing atmosphere to a temperature that is sufficiently high to vaporize the cleaning residue from the surface, thereby forming a cleaned surface; and
(d) forming a second layer over the cleaned surface.

2. A method according to claim 1 wherein (c) comprises heating the surface to a temperature of at least about 100° C.

3. A method according to claim 1 wherein (c) comprises heating the surface in a substantially non-oxidizing atmosphere comprising less than about 1% by volume of oxygen gas.

4. A method according to claim 3 wherein (c) comprises heating the surface in an environment comprising at least about 99% percent by volume of nitrogen.

5. A method according to claim 3 wherein (c) comprises heating the surface while maintaining a vacuum pressure.

6. A method according to claim 1 wherein (b) comprises cleaning the surface with a cleaning fluid comprising an acidic solution or a basic solution.

7. A method according to claim 1 wherein (d) comprises generating an electrical arc that at least partially liquefies a metal material, and passing a pressurized gas past the liquefied metal material to propel the liquefied metal material towards the surface.

8. A method according to claim 7 wherein (d) comprises forming a second layer comprising at least one of aluminum, titanium, tantalum, copper and chromium.

9. A method according to claim 1 wherein the structure comprises at least one of aluminum, titanium, tantalum, stainless steel, copper and chromium.

10. A method according to claim 1 further comprising bead blasting the exposed surface.

11. A component fabricated according to the method of claim 1, wherein the component comprises at least a portion of one or more of an enclosure wall, a chamber shield, a gas energizer, a gas distributor, an exhaust conduit, and a substrate support.

12. A method of refurbishing a component of a process chamber, the component comprising a structure having an overlying coating comprising a first metal layer, the method comprising:
(a) removing the first metal layer to form an exposed surface on the structure;
(b) during or after (a), cleaning the exposed surface with a first cleaning fluid, thereby depositing first cleaning residue on the exposed surface;
(c) texturing the exposed surface by propelling blasting beads towards the surface;
(d) in a first baking step, heating the exposed surface in a substantially non-oxidizing environment to a temperature that is sufficiently high to vaporize first cleaning residue from the exposed surface, the substantially non-oxidizing atmosphere comprising less than about 1% by volume of oxygen gas;
(e) forming a second metal layer over the exposed surface, the second metal layer comprising a top surface;
(e) cleaning the top surface of the second metal layer with a second cleaning fluid, thereby depositing second cleaning residue on the top surface; and
(g) in a second baking step, heating the top surface of the second metal layer to a temperature that is sufficiently high to vaporize second cleaning residue from the top surface.

13. A method according to claim 12 wherein (d) comprises heating the surface to a temperature of at least about 100° C.

14. A method according to claim 12 wherein (d) comprises heating the surface in an environment comprising at least about 99% percent by volume of nitrogen gas.

15. A method according to claim 12 wherein (d) comprises heating the surface while maintaining a vacuum pressure.

16. A method according to claim 12 wherein (b) comprises cleaning the exposed surface with cleaning fluid comprising de-ionized water, an acidic solution, or a basic solution.

17. A method according to claim 12 wherein (e) comprises generating an electrical arc that at least partially liquefies a metal material, and passing a pressurized gas past the liquefied metal material to propel the liquefied metal material towards the surface.

18. A method according to claim 17 wherein (e) comprises forming a second metal layer comprising at least one of aluminum, titanium, tantalum, copper and chromium.

19. A method according to claim 12 wherein the structure comprises at least one of aluminum, titanium, tantalum, stainless steel, copper and chromium.

20. A component fabricated according to the method of claim 12, wherein the component comprises at least a portion of one or more of an enclosure wall, a chamber shield, a gas energizer, a gas distributor, an exhaust conduit, and a substrate support.
